(19) United States
(12) Patent Application Publication
(10) Pub. No.: US 2001/0022174 A1
(43) Pub. Date: Sep. 20, 2001

(54) Pressure control for supercharged engine

(76) Inventors: Yasuyuki Suzuki, Iwata-shi (JP); Yukio Shimojikkoku, Iwata-shi (JP)

Correspondence Address: ERNEST A. BEUTLER, ATTORNEY AT LAW, 500 NEWPORT CENTER DRIVE, SUITE 945, NEWPORT BEACH, CA, 92660, US

(21) Appl. No.: 09/681,294

(22) Filed: Mar. 14, 2001

(30) Foreign Application Priority Data
Mar. 17, 2000 (JP) 2000-077281

(51) Int. Cl. F02B 33/00

(52) U.S. Cl. 123/559.1

(57) ABSTRACT

A supercharged internal combustion engine embodying a construction for maintaining the desired supercharger pressure in the induction system and avoiding the objectionable noises that occur with conventional system wherein the bypass flow is all discharged into the induction system upstream of the supercharger. This is done by bypassing the intake air from the area between the supercharger and the combustion chamber to a point other than in said induction system an particularly to the engine exhaust system.

### BACKGROUND OF THE INVENTION

This invention relates to an intake air system for an internal combustion engine and more particularly to an improved pressure control arrangement for a supercharged internal combustion engine.

In conjunction with engine design, it has been proposed to use some form of compressor or supercharger in the intake system so as to force more air into the combustion chamber to improve performance output. Various types of superchargers and/or turbochargers, generically called “superchargers” are utilized for this purpose. In conjunction with such systems, it has been the practice to provide an arrangement for relieving the pressure generated by the superchargers so that the full pressure is not introduced into the induction system under at least some running conditions.

It has generally been the practice to reduce the pressure in the induction system downstream of the supercharger by utilizing a bypass valve that bypasses the air from the induction system downstream of the supercharger to a point in the induction system upstream of the supercharger. When this is done, however, the opening of the bypass valve causes a surge of air to flow into the induction system, which creates noise in the intake side. This can be objectionable to the operator.

It is, therefore, a principal object to this invention to provide an improved pressure control arrangement for a supercharged internal combustion engine wherein pressure of control is accomplished without attendant noise during the time when pressure relief is occurring.

It is a further object to this invention to provide an improved pressure relief system for a supercharged internal combustion engine.

### SUMMARY OF THE INVENTION

This invention is adapted to be embodied in a supercharged internal combustion engine having an induction system that includes a supercharger interposed between an air inlet device and the combustion chambers of the engine. A pressure relief system is provided having a bypass passageway interposed between the supercharger and the combustion chamber and which has a first branch having a pressure control valve therein for bypassing air from the supercharger back to the induction system between the air inlet device and the supercharger. In addition, there is provided a decompression device in the bypass passage for bypassing the intake air from the area between the supercharger and the combustion chamber to a point other than the induction system. The system is operated so that the flow through the bypass passage is initiated at least at the time the pressure relief valve is opened so as to reduce the pressure exerted in the intake system between the supercharger and the air inlet device.

### BRIEF DESCRIPTION OF DRAWINGS

FIG. 1 is a partially schematic view of an internal combustion engine constructed in accordance with an embodiment of the invention and showing two alternate discharge paths from the decompression valve.

FIG. 2 is a graphical view showing the timing of the opening and closing of the pressure control and decompression valves.

### DETAILED DESCRIPTION

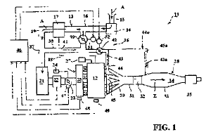

Referring now in detail to the drawings and initially to FIG. 1, an internal combustion engine constructed and operated in accordance with the embodiments of the invention is indicated generally by the reference numeral 11. For the most part, the engine components are shown schematically because they can be of any type generally known or desired in the art.

The engine 11 includes a main engine body 12 which may be comprised of a cylinder block, cylinder head, crankcase and the well known associated components. In the illustrated embodiment, the engine 11 is shown as an in-line four-cylinder type engine; however, the invention can be practiced with other types of engine constructions.

An induction system, indicated generally by the reference numeral 13 is provided for the engine 11. This induction system 13 includes an air inlet device 14 having an atmospheric air inlet opening 15 through which air is inducted as indicated by the air flow arrows A.

A supercharger inlet pipe 16 forms a portion of the induction system and delivers the air from the air inlet device 14 to a supercharger, indicated schematically by the reference numeral 17. This supercharger 17 may be of the type that is driven from the output shaft of the engine 11 and the drive therefore is indicated schematically by the phantom line 18. Of course, other types of supercharger drives can be employed.

An outlet passage 19 leads from the pressure side of the supercharger 17 to an intercooler, indicated generally by the reference numeral 21. The intercooler 21, in turn, discharges to a flow sensor 22, which, in turn, discharges into a throttle, body 23 in which a flow controlling throttle valve is positioned. A suitable actuator 24 is provided for positioning the throttle valve of the throttle body 23. This may be either a linkage system to an accelerator pedal or a “fly by the wire” type of control system.

In turn, the throttle body 23 supplies air to a plenum chamber 25 of an intake manifold having individual runners 26 which extend to intake ports of the engine 11.

A suitable fuel supply is provided for introducing fuel to the engine 11 for mixture with the inducted air. This fuel supply system is shown schematically at 27 and can comprise either carburetors, fuel injectors or any other type of arrangement for supplying fuel. If fuel injectors are employed, they can be of the direct injection type or manifold injection.

The charge, which is introduced to the combustion chambers of the engine 11, is ignited by a suitable ignition system and the burnt exhaust gases are discharged to the atmosphere through an exhaust system, indicated generally by the reference numeral 28.

This exhaust system 28 is comprised of an exhaust manifold 29 having a discharge end 31 in which a catalyst bed of a suitable type 32 is provided. The flow of the exhaust gases is indicated by the arrow E and this also passes through a first silencer 33 forming an expansion chamber 34. An additional silencing device or muffler 35 is positioned downstream of the expansion chamber 34.

It is to be understood that the construction of the engine 11 as thus far described is only intended to show the environment in which the invention can be practiced. As has been previously noted, the construction of the engine 11 at least in so far as the components thus far described may be considered to be of any known or conventional type.

The invention, as should be apparent from the foregoing discussion, deals with the pressure control system for preventing too high a pressure from existing in the induction system downstream of the supercharger 17. This comprises a pressure relief system, indicated generally by the reference numeral 36, which communicates with the induction system in the conduit 19 at a point indicated at 37.

A bypass conduit 38 intersects the conduit 19 at this point. A pressure control valve, indicated generally by the reference numeral 39 communicates a portion 41 of the passage 38 back with the intake passage 16 when the bypass valve 39 is opened. Then, the bypass flow flows in the direction indicated by the dot dash arrows in FIG. 1.

In addition to the bypass valve 39, there is further provided a decompression valve 42 which communicates with the passage portion 41 and permits a bypass flow when opened in the direction indicated by the arrow 43 to a decompression manifold, indicated generally by the reference numeral 44 and which has branch portions 45 which communicate with each of the branch passages of the exhaust manifold 29.

The operation of the bypass valve 39 and the decompression valve 42 is controlled by an ECU, indicated generally by the reference numeral 46 and which may be the main ECU control for the engine. This ECU 46 receives input signals from the air flow or pressure sensor 22 and also from a throttle position sensor 47, an intake manifold pressure sensor 48 and an engine speed sensor 49 so as to control servo-motors 51 and 52 associated with the bypass valve 39 and decompression valve 42, respectively.

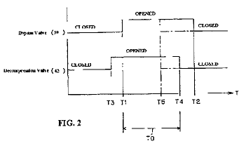

As seen in FIG. 2, the control strategy of the ECU 46 is such that when pressure relief is required due to higher intake system pressure than required for good engine operation at the specific engine running conditions, the decompression valve 42 is opened at a time period T3 which is preferably a short time period or simultaneously with the time of opening T1 of the bypass valve 39.

By doing this, the pressure is relieved at least partially through the decompression manifold 44 into the exhaust system 28 so that any pressure pulse will be silenced by the silencing arrangement of the exhaust system 28 and not into the intake system where it could cause objectionable noise.

The control strategy illustrated in the solid line view of FIG. 2 indicates that the decompression valve is closed at a time T4 after the time interval T0 and before the bypass valve is closed at the time T2. Since the initial pressure relief relieves the main pressure pulse and avoids the noise, it is not necessary to maintain the decompression valve open for a longer time period. Under other running conditions, as indicated by the broken line curves in FIG. 2, the bypass valve and decompression valve may be closed both at the same time. However, the decompression valve is never closed after the bypass valve is closed.

In the solid line view of FIG. 1, the decompression valve discharges into the exhaust manifold 29. However, the system also may be operated so as to cause the decompression gases to flow into the expansion chamber 34 and this alternate location is shown in phantom lines in FIG. 1 and the similar components identified by the same reference numerals with the suffix “a” added.

Thus, from the foregoing description it should be readily apparent that the described construction provides a very effective way of maintaining the desired supercharger pressure in the induction system and avoiding the objectionable noises that occur with conventional system wherein the bypass flow is all discharged into the induction system upstream of the supercharger. Of course, the foregoing description is that of preferred embodiments of the invention and various changes and modifications may be made without departing from the spirit and scope of the invention, as defined by the appended claims.

1. A supercharged internal combustion engine having at least one combustion chamber, an induction system including a supercharger interposed between an air inlet device and said combustion chamber, a pressure relief system a bypass passageway interposed between said supercharger and said combustion chamber, said pressure relief system having a first branch having a pressure control valve therein for bypassing air from said supercharger back to said induction system between said air inlet device and said supercharger and a second branch including a decompression device for bypassing the intake air from the area between said supercharger and said combustion chamber to a point other than in said induction system.

2. A supercharged internal combustion engine as set forth in claim 1 further including a control for so that the flow through the second branch is initiated at least at the time the first branch is opened so as to reduce the pressure exerted in the intake system between the supercharger and the air inlet device.

3. A supercharged internal combustion engine as set forth in claim 2 wherein the decompression device comprises a decompression valve for controlling the flow through the second branch.

4. A supercharged internal combustion engine as set forth in claim 1 wherein said engine has an exhaust system for discharging exhaust products to the atmosphere.

5. A supercharged internal combustion engine as set forth in claim 4 wherein the decompression device bypasses air to the exhaust system.

6. A supercharged internal combustion engine as set forth in claim 5 wherein the exhaust system includes a silencing device and the bypassed air is delivered upstream of said silencing device.

7. A supercharged internal combustion engine as set forth in claim 6 further including a control for so that the flow through the second branch is initiated at least at the time the first branch is opened so as to reduce the pressure exerted in the intake system between the supercharger and the air inlet device.

8. A supercharged internal combustion engine as set forth in claim 7 wherein the decompression device comprises a decompression valve for controlling the flow through the second branch.

9. A supercharged internal combustion engine as set forth in claim 5 wherein the exhaust system includes a silencing device and the bypassed air is delivered directly to said silencing device.

10. A supercharged internal combustion engine as set forth in claim 9 further including a control for so that the flow through the second branch is initiated at least at the time the first branch is opened so as to reduce the pressure exerted in the intake system between the supercharger and the air inlet device.

11. A supercharged internal combustion engine as set forth in claim 10 wherein the decompression device comprises a decompression valve for controlling the flow through the second branch.
